(19) United States
(12) Patent Application Publication
(10) Pub. No.: US 2022/0361706 A1
(43) Pub. Date: Nov. 17, 2022

(54) COFFEE MAKER COVER AND CAPSULE COFFEE MAKER

(71) Applicant: Shenzhen Chenbei Technology Co., Ltd., Shenzhen (CN)

(72) Inventors: Lei LIU, Shenzhen (CN); Xinhang CHEN, Shenzhen (CN)

(21) Appl. No.: 17/742,352

(22) Filed: May 11, 2022

(30) Foreign Application Priority Data
May 11, 2021 (CN) 202110513388.5

(51) Int. Cl. A47J 31/44; A47J 31/36; A47J 31/46

(52) U.S. Cl. CPC A47J 31/4407; A47J 31/3695; A47J 31/46

(57) ABSTRACT

The application discloses a coffee maker cover and a capsule coffee maker. The coffee maker cover includes an upper cover structure, a lower cover structure and a needle assembly, where the lower cover structure is installed on the upper cover structure in a manner of being capable of moving relative to the upper cover structure, the lower cover structure has at least a first position away from the upper cover structure and a second position close to the upper cover structure, and the needle assembly is installed on the upper cover structure; when the lower cover structure is at the first position, the needle assembly is hidden in the lower cover structure; and when the lower cover structure is at the second position, the needle assembly extends from the lower cover structure to expose a needle outlet and the needle assembly is in hermetic communication with a water inlet channel. The capsule coffee maker can protect a user from stab caused by the user's misoperation and touch with the needle assembly, thereby improving use safety of the coffee maker. In addition, when the needle assembly is hidden in the lower cover structure, the overall shape of the coffee maker is more beautiful.

### CROSS REFERENCE

This is a non-provisional application which claims priority to a Chinese patent application having an application number of CN202110513388.5, and a filing date of May 11, 2021, the entire contents of which is hereby incorporated by reference.

### TECHNICAL FIELD

The application relates to the field of household appliance technologies, and in particular, to a coffee maker cover and a capsule coffee maker.

### BACKGROUND

Capsule coffee is an edible consumable that uses a capsule made of a material such as aluminum or plastic to store coffee powder. Before the coffee is consumed, the coffee powder in the capsule can be isolated from the outside air, so that the coffee powder can maintain high quality for a long time. A capsule coffee maker is a coffee brewing device specially designed for capsule coffee. When the capsule coffee maker is used to brew coffee, the capsule coffee is placed in a corresponding position of the capsule coffee maker first and then a coffee maker cover is placed over the capsule coffee maker, a needle on the coffee maker cover pierces capsule coffee, and then coffee brewing water enters the capsule coffee through the needle and is mixed with the coffee powder to brew a fragrant coffee.

In an existing capsule coffee maker, the needle on the coffee maker cover is usually fixedly arranged and exposed. When the coffee maker cover is not placed over the capsule coffee maker, the exposed needle easily stabs a user and affects aesthetics of an overall shape of the coffee maker.

### SUMMARY

The application provides a coffee maker cover and a capsule coffee maker, aiming to hide a needle and improve aesthetics of an overall shape of a coffee maker.

According to a first aspect, a coffee maker cover is provided in an embodiment, including:

an upper cover structure formed with a water inlet channel;

a lower cover structure, wherein the lower cover structure is installed on the upper cover structure in a manner of being capable of moving relative to the upper cover structure, and the lower cover structure has at least a first position away from the upper cover structure and a second position close to the upper cover structure; and

a needle assembly, where the needle assembly is installed on the upper cover structure, a water outlet channel is provided in the needle assembly, and the needle assembly has a needle outlet communicated with the water outlet channel, where

when the lower cover structure is at the first position, the needle assembly is hidden in the lower cover structure; and when the lower cover structure is at the second position, the needle assembly extends from the lower cover structure to expose the needle outlet and the water outlet channel of the needle assembly is in hermetic communication with the water inlet channel.

In an embodiment, the needle assembly is fixedly installed on the upper cover structure, and the needle assembly is always in hermetic communication with the water inlet channel.

In an embodiment, the upper cover structure includes a first upper cover, a first water inlet portion is formed on one side of the first upper cover facing the lower cover structure, the first water inlet portion forms the water inlet channel, and the needle assembly is connected to the first water inlet portion.

In an embodiment, the upper cover structure includes a first upper cover and a water inlet head, the water inlet head is installed on one side of the first upper cover facing the lower cover structure, the water inlet head is formed with the water inlet channel, and the needle is connected to the water inlet head.

In an embodiment, the coffee maker cover further includes a first elastic telescopic structure arranged between the first upper cover and the lower cover structure, so that the lower cover structure is capable of being switched between the first position and the second position relative to the first upper cover.

In an embodiment, the first elastic telescopic structure includes a first elastic member arranged between the first upper cover and the lower cover structure; the first elastic telescopic structure further includes a first guide post arranged between the first upper cover and the lower cover structure, the first guide post is capable of extending out of the first upper cover or the lower cover structure, and the first elastic member sleeves the first guide post.

In an embodiment, the first upper cover includes a cover portion and an extension portion, the cover portion has a side cover surface extending toward one side at which the lower cover structure is located, the extension portion extends from an edge of the side cover surface from the outside to the inside to form a support portion opposite to the cover portion, the support portion encloses and forms an opening, the first guide post is arranged between the cover portion and the extension portion, the lower cover structure includes a force-bearing portion and a flange located at an edge of the force-bearing portion, the flange is provided corresponding to the support portion, and the force-bearing portion is provided corresponding to the opening.

In an embodiment, the needle assembly is movably installed on the upper cover structure, and the lower cover structure moves from the first position to the second position, the lower cover structure is capable of acting on the upper cover structure to move the needle assembly to a position at which the water outlet channel of the needle assembly is in hermetic communication with the water inlet channel.

In an embodiment, the upper cover structure includes a second upper cover and a needle base, the needle base is movably installed on the second upper cover, and the needle assembly is installed on the needle base.

In an embodiment, a second water inlet portion is formed on one side of the second upper cover facing the lower cover structure, the water inlet channel is formed in the second water inlet portion, and a periphery of the second water inlet portion is sleeved with a second sealing member.

In an embodiment, the needle base is provided with a plurality of second guide posts in a circumferential direction thereof, the plurality of second guide posts are capable of penetrating through the second upper cover, the second guide posts are each sleeved with a second elastic member, and the second elastic member and the second guide post form a second elastic telescopic structure.

In an embodiment, the coffee maker cover further includes a third elastic telescopic structure arranged between the second upper cover and the lower cover structure, so that the lower cover structure is capable of being switched between the first position and the second position relative to the second upper cover.

In an embodiment, the lower cover structure includes a lower cover, and a needle hole is formed in the lower cover; when the lower cover is at the first position, the needle assembly is capable of being hidden in the needle hole, and when the lower cover is located at the second position, the needle outlet of the needle assembly extends out from the needle hole.

In an embodiment, the lower cover structure further includes a sealing member, the sealing member is nested in a periphery of the needle hole, a plurality of sealing rings are convexly formed at the bottom of the sealing member, the plurality of sealing rings are spaced with each other from the inside to the outside, the sealing member is provided with a through hole for the needle to pass through, and a diameter of the through hole is smaller than an outer diameter of the needle.

In an embodiment, the lower cover structure has a sprinkling hole; when the lower cover structure is at the first position, a cavity communicated with the sprinkling hole is formed between the upper cover structure and the lower cover structure; a first end of the needle assembly is fixedly installed on a side of the upper cover structure facing the cavity, a second end of the needle assembly extends toward a side where the lower cover structure is located, and the water outlet channel is communicated with the water inlet channel;

when the lower cover structure is at the first position, the needle outlet is located inside the cavity, and the cavity is communicated with the water inlet channel through the water outlet channel and the needle outlet, so that the sprinkling hole is communicated with the water inlet channel; and

when the lower cover structure is at the second position, the needle outlet extends to the outside of the lower cover structure, and disables communication between the water outlet channel and the cavity, thereby disabling communication between the sprinkling hole and the water inlet channel.

According to a second aspect, a capsule coffee maker is provided in an embodiment, including a machine base and the coffee maker cover according to the first aspect.

The embodiments of the application have the following beneficial effects:

In the coffee maker cover and the capsule coffee maker according to the foregoing embodiments, after the coffee maker cover is placed over the capsule coffee maker, a lower cover structure is squeezed by capsule coffee, and in this case, the lower cover structure moves from a first position to a second position; at the same time, a needle assembly extends from the lower cover structure to pierce capsule coffee, and then water flowing out from a water inlet channel and the needle assembly in sequence is used to brew the coffee. After the coffee maker cover is removed, the lower cover structure is not subjected to squeezing force; in this case, the lower cover structure is switched to the first position, and the needle assembly is hidden in the lower cover structure. This can protect a user from stab caused by the user's misoperation and touch with a needle, thereby improving use safety of the coffee maker. In addition, when the needle assembly is hidden in the lower cover structure, an overall shape of the coffee maker is more beautiful.

### BRIEF DESCRIPTION OF THE DRAWINGS

To explain the embodiments of the application or the technical solutions in the prior art more clearly, the following will briefly describe the accompanying drawings that need to be used in the description of the embodiments or the prior art. Obviously, the accompanying drawings in the following description show only some embodiments of the application, and a person of ordinary skill in the art can still derive other accompanying drawings from these accompanying drawings without creative efforts.

Among the figures,

FIG. 1 is a schematic structural diagram showing a capsule coffee maker in an embodiment;

FIG. 2 is a schematic exploded view showing a capsule coffee maker in an embodiment;

FIG. 3 is a sectional view showing a coffee maker cover in a closed state in an embodiment;

FIG. 4 is a partial enlarged view showing a position A in FIG. 3;

FIG. 5 is a sectional view showing a coffee maker cover in an opened state in an embodiment;

FIG. 6 is a partial enlarged view showing a position B in FIG. 5;

FIG. 7 is a schematic structural diagram showing a lower cover structure at a first position in an embodiment;

FIG. 8 is a schematic structural diagram showing a water inlet head in an embodiment;

FIG. 9 is a schematic exploded view showing a coffee maker cover in an embodiment;

FIG. 10 is another schematic exploded view showing a coffee maker cover in an embodiment;

FIG. 11 is a schematic structural diagram showing a lower cover structure at a first position in an embodiment;

FIG. 12 is a schematic structural diagram showing a lower cover structure at a second position in an embodiment.

### SYMBOL DESCRIPTION OF MAIN COMPONENTS

100—Upper cover structure; 101—water inlet channel; 110—first upper cover; 120—water inlet head; 130—second upper cover; 140—needle base; 150—second sealing member; 111—mounting convex column; 112—cover portion; 113—extension portion; 121—water inlet; 122—water inlet section; 123—water conveying section; 124—connecting portion; 131—second water inlet portion; 1121—side cover surface; 1131—support portion; 1221—ridge; 1241—connecting groove; 1131a—opening;
200—lower cover structure; 210—first lower cover; 220—first sealing member; 230—second lower cover; 240—third sealing member; 211—first needle hole; 212—force-bearing portion; 213—flange 221—sealing ring; 222—first through hole; 231—second needle hole; 241—second through hole;
300—needle assembly; 310—first tip; 320—needle tube; 330—second tip; 321—needle tube flow channel; 322—needle outlet;
400—first elastic telescopic structure; 410—first elastic member; 420—first guide post;
500—second elastic telescopic structure; 510—second elastic member; 520—second guide post; 530—limiting member;
600—third elastic telescopic structure; 610—third elastic member; 620—second guide seat; 630—second guide protrusion;
10—machine base; 11—machine body; 12—supporting device; 13—kettle; 11a—assembly cavity; 11b—kettle accommodating cavity; 11c—limiting groove; 11d—handhold portion accommodating groove; 11e—rotating base; 12a—support; 12b—capsule cup; 12c—handhold portion; 12a1—long convex column; 12a2—limiting protrusion;
20—coffee maker cover; 21—clamping lug;
30—capsule coffee.

### DETAILED DESCRIPTION OF THE PREFERRED EMBODIMENT

To facilitate the understanding of the application, the application will be described more comprehensively below with reference to relevant accompanying drawings. The accompanying drawings show preferred embodiments of the application. However, the application may be embodied in many other different forms and is not limited to the embodiments described herein. Rather, these embodiments are provided so that the understanding of the disclosure of the application is more thorough and comprehensive.

It should be noted that when an element is referred to as being “fixed” to another element, the element may be directly fixed to the another element, or an intermediate element may be present. When an element is considered as being “connected” to another element, the element may be directly connected to the another element, or an intermediate element may be present at the same time. The terms “vertical”, “horizontal”, “left”, “right” and similar expressions used herein are for the purpose of illustration only.

Unless otherwise defined, all technological and scientific terms used herein have the same meanings as commonly understood by a person skilled in the art to which the application pertains to. Herein, the terms used in the description of the application are merely for the purpose of describing specific embodiments, but are not intended to limit the application. The term “and/or” as used herein includes any and all combinations of one or more related listed items.

An embodiment of the application provides a capsule coffee maker, and the capsule coffee maker is used to brew capsule coffee. In addition, the capsule coffee maker further has excellent safety in use and a beautiful shape.

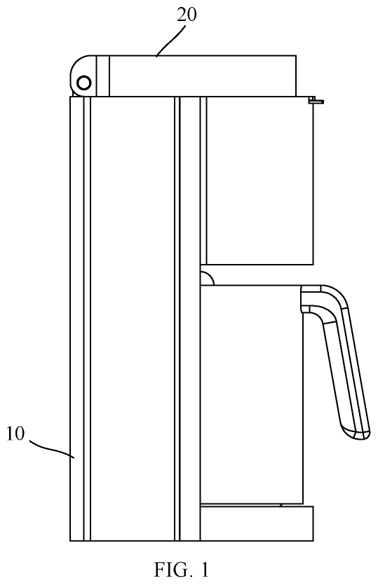

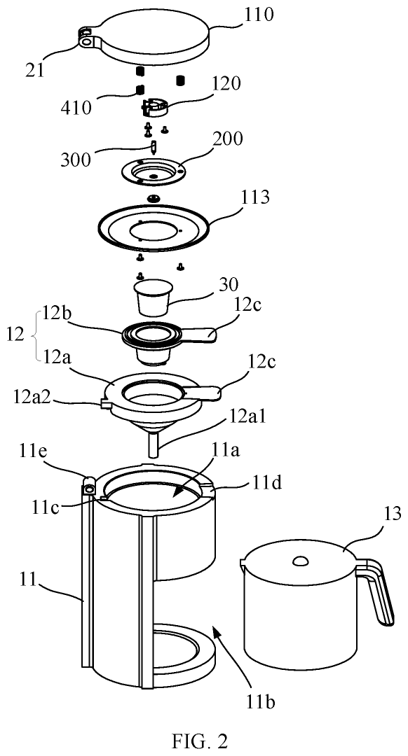

Referring to FIG. 1 and FIG. 2, the capsule coffee maker includes a machine base 10 and a coffee maker cover 20 rotatably installed on the machine base 10. The coffee maker cover 20 is rotatably arranged on the machine base 10 to achieve the objective of opening or closing the machine base 10.

It may be understood that when the capsule coffee 30 is placed on the machine base 10, the coffee maker cover 20 can pierce the capsule coffee 30 during the closing process of the coffee maker cover 20 on the machine base 10, and then the capsule coffee 30 is brewed.

The machine base 10 includes a machine body 11, a supporting device 12, and a kettle 13. The machine body 11 is usually designed into an upright cylinder (certainly, the machine body may alternatively be in another shape). The top of the machine body 11 has an assembly cavity 11a, and a lower portion of the machine body 11 further has a kettle accommodating cavity 11b communicated with the assembly cavity 11a. The supporting device 12 is detachably installed in the assembly cavity 11a, the capsule coffee 30 can be placed in the supporting device 12, and the kettle 13 can be placed in the kettle accommodating cavity 11b. The supporting device 12 is directly communicated with the kettle 13, and the capsule coffee 30 is brewed in the supporting device 12 and then sent into the kettle 13.

The supporting device 12 may include a support 12a and a capsule cup 12b. The support 12a and the capsule cup 12b are each provided with a handhold portion 12c. When the capsule cup 12b is placed into the support 12a, the two handhold portions 12c overlap to facilitate holding and placing the support 12a and the capsule cup 12b into the assembly cavity 11a by a user. The capsule cup 12b is configured to accommodate the capsule coffee 30 and limit the capsule coffee 30. The support 12a functions to support the capsule cup 12b. In addition, the bottom of the support 12a is provided with a long convex column 12a1 for liquid to pass through, and the long convex column 12a1 extends into the kettle 13.

To improve stability of the supporting device 12 on the machine body 11, a limiting protrusion 12a2 is further formed on an outer edge of the support 12a, and a limiting groove 11c capable of accommodating the limiting protrusion 12a2 is provided at a corresponding position of the machine body 11. After the support 12a is placed on the machine body 11, the limiting protrusion 12a2 is clamped in the limiting groove 11c, which can prevent the support 12a from moving on the machine body 11 in a circumferential direction.

In addition, the machine body 11 may be further provided with a handhold portion accommodating groove 11d. The respective handhold portions 12c of the capsule cup 12b and the support 12a may be accommodated in the handhold portion accommodating groove 11d, to further stabilize the supporting device 12 on the machine body 11.

One side of a top position of the machine body 11 is further provided with a rotating base 11e, and the rotating base 11e is a hollow cylinder. In addition, a pair of clamping lugs 21 that can be clamped to the rotating base 11e and has a through hole is arranged at a corresponding position of the coffee maker cover 20. In this case, the coffee maker cover 20 can be rotatably installed on the machine base 10 by using a rotating shaft to penetrate through the clamping lugs 21 and the rotating base 11e in sequence.

In addition to the foregoing methods, to install the coffee maker cover 20, the clamping lugs 21 may alternatively have no through hole and opposite sides thereof may be provided with protrusions, and the protrusions are clamped into the rotating base 11e. In this case, the protrusions act as the foregoing rotating shaft.

Referring to FIG. 2 to FIG. 7, the coffee maker cover 20 in the embodiment of the application includes an upper cover structure 100, a lower cover structure 200, and a needle assembly 300.

A water inlet channel 101 is formed in the upper cover structure 100. The lower cover structure 200 is installed on the upper cover structure 100 in a manner of being capable of moving relative to the upper cover structure 100, and the lower cover structure 200 has at least a first position away from the upper cover structure 100 and a second position close to the upper cover structure 100. The needle assembly 300 is installed on the upper cover structure 100, a water outlet channel is provided in the needle assembly 300, and the needle assembly 300 is provided with a needle outlet 322 communicated with the water outlet channel. When the lower cover structure 200 is at the first position, the needle assembly 300 is hidden in the lower cover structure 200; and when the lower cover structure 200 is at the second position, the needle assembly 300 extends from the lower cover structure 200 to expose the needle outlet 322 and the water outlet channel of the needle assembly 300 is in hermetic communication with the water inlet channel 101. That is, the needle assembly 300 is communicated with the inside of the water inlet channel 101, and a joint between the two is circumferentially hermetically assembled.

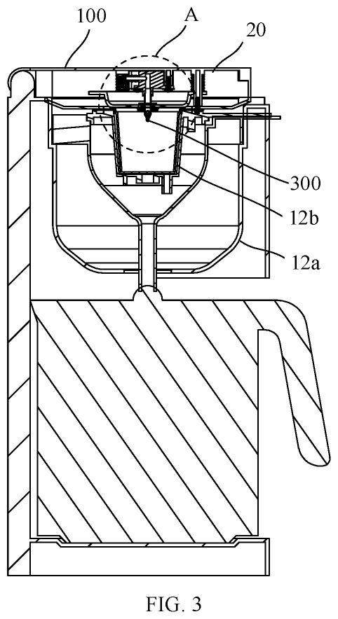

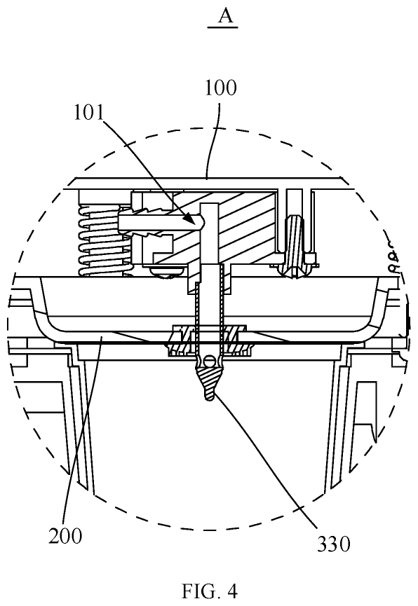

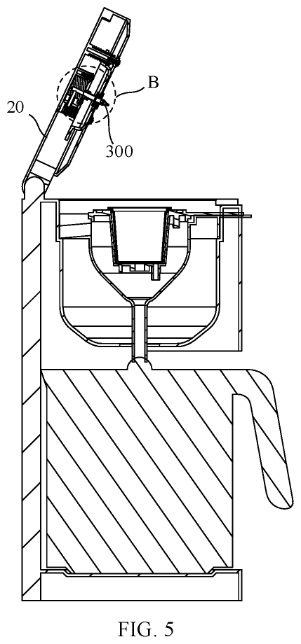

After the coffee maker cover 20 is placed over the capsule coffee maker, as shown in FIG. 3 and FIG. 4, the lower cover structure 200 is squeezed by capsule coffee 30, and in this case, the lower cover structure 200 moves from the first position to the second position; at the same time, the needle assembly 300 extends from the lower cover structure 200 to pierce capsule coffee 30, and then water flowing out from the water inlet channel 101 and the needle assembly 300 in sequence is used to brew the coffee. After the coffee maker cover 20 is removed, as shown in FIG. 5 and FIG. 6, the lower cover structure 200 is not subjected to squeezing force; in this case, the lower cover structure 200 is switched to the first position, and the needle assembly 300 is hidden in the lower cover structure 200. This can protect a user from stab caused by the user's misoperation and touch with the needle assembly 300, thereby improving use safety of the coffee maker. In addition, when the needle assembly 300 is hidden in the lower cover structure 200, an overall shape of the coffee maker is more beautiful.

In a first type of embodiments, referring to FIG. 2 to FIG. 7, the needle assembly 300 is fixedly installed on the upper cover structure 100, and the needle assembly 300 is always in hermetic communication with the water inlet channel 101.

It may be understood herein that the needle assembly 300 is directly and fixedly installed on the upper cover structure 100, so that the structural design for sealing may be omitted or simplified.

In a specific embodiment, the upper cover structure 100 includes a first upper cover 110, a first water inlet portion (for related accompanying drawings of the first water inlet portion, reference may be made to a second water inlet portion 131 below for understanding) is formed on one side of the first upper cover 110 facing the lower cover structure 200, the first water inlet portion forms the water inlet channel 101, and the needle assembly 300 is connected to the first water inlet portion.

The first upper cover 110 may be manufactured by injection molding. In this case, the first upper cover 110 and the first water inlet portion have an integrated structure. In addition, in the process of injection molding, the needle assembly 300 may be used as an embedded part to be directly connected to the first water inlet portion after injection molding.

The water inlet channel 101 formed by the first water inlet portion is communicated with the outside. When one end of the water inlet channel 101 located outside is connected to a component capable of conveying liquid, such as a water conveying hose, the water for brewing coffee can be conveyed into the water inlet channel 101 and the needle assembly 300 until the water enters the capsule coffee 30.

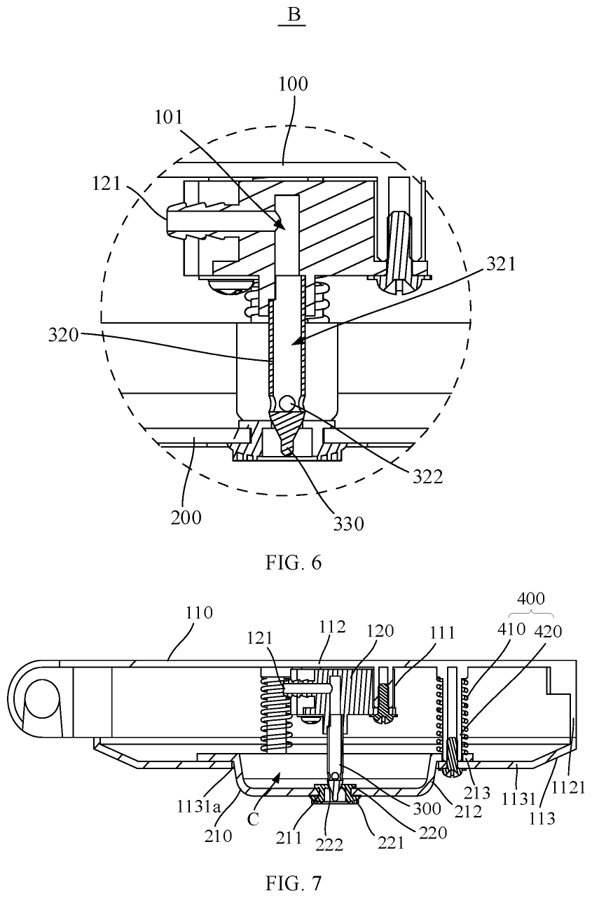

In another specific embodiment, referring to FIG. 2 and FIG. 7, the upper cover structure 100 includes a first upper cover 110 and a water inlet head 120, the water inlet head 120 is installed on one side of the first upper cover 110 facing the lower cover structure 200, the water inlet head 120 forms the water inlet channel 101, and the needle assembly 300 is connected to the water inlet head 120.

The water inlet head 120 is used as a transitional component between the first upper cover 110 and the needle assembly 300, and is installed on the first upper cover 110 as an independent component. On one hand, this facilitates subsequent maintenance and replacement of the water inlet head 120, such as dredging of the water inlet channel 101 in the water inlet head 120. On the other hand, the water inlet 120 as a whole is disposed inside the upper cover structure 100. In this case, the water conveying hose and the like may be directly communicated with the water inlet head 120 from the inside of the upper cover structure 100, so that the water conveying hose is hidden in the upper cover structure 100, so as to achieve the objective of changing the water conveying manner.

The water inlet channel 101 formed by the water inlet head 120 forms a water inlet 121 inside the upper cover structure 100. When the water inlet 121 is connected to a component capable of conveying liquid, such as a water conveying hose, the water for brewing coffee can be conveyed into the water inlet channel 101 and the needle assembly 300 until the water enters the capsule coffee 30.

The water inlet head 120 may be manufactured by injection molding. In addition, in the process of injection molding, the needle assembly 300 may be used as an embedded part to be directly connected to the water inlet head 120 after injection molding. In this case, the water inlet head 120 and the needle assembly 300 form an integrated structure.

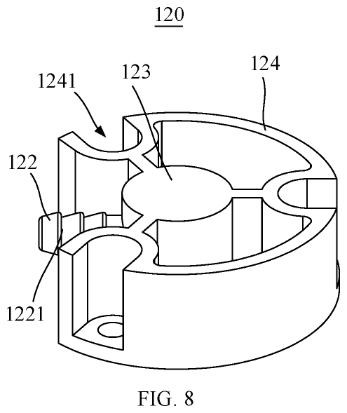

In a more specific embodiment, referring to FIG. 2, FIG. 7 and FIG. 8, the water inlet head 120 has a water inlet section 122, a water conveying section 123, and a connecting portion 124 surrounding a periphery of the water conveying section 123. The water inlet section 122 and the water conveying section 123 jointly form the water inlet channel 101, and the connecting portion 124 is configured to connect the water inlet head 120 to the first upper cover 110.

Specifically, the water conveying section 123 is a hollow cylindrical body with an open lower end, and the water inlet section 122 is a hollow cylinder. Hollow portions of the water inlet section 122 and the water conveying section 123 are communicated to form a water inlet channel 101. The water inlet section 122 is hollow and a plurality of spaced ridges 1221 are formed on an outer surface of the water inlet section 122, to facilitate connection to a water conveying hose and the like. Water may enter the needle assembly 300 through the water inlet section 122 and the water conveying section 123 in sequence.

The connecting portion 124 includes a plurality of connecting grooves 1241 that are evenly spaced along a circumferential direction. The connecting grooves 1241 extend along an axial direction of the water inlet head 120, and the cross section of each of the connecting grooves 1241 along a radial direction of the water inlet head 120 is semicircular (or the connecting groove may alternatively be a groove that is circular or has another shape), and the bottom of the connecting groove 1241 is provided with threaded mounting holes. A side of the first upper cover 110 facing the lower cover structure 200 is provided with a plurality of mounting convex column 111. The mounting convex column 111 may be accommodated in the foregoing connecting grooves 1241, and then the water inlet head 120 may be installed on the first upper cover 110 by screwing screws and other fasteners into the threaded mounting holes and mounting convex columns 111 in sequence.

It should be noted here that, preferably, the connecting grooves 1241 and the mounting convex columns 111 have a corresponding number relationship. For example, when three connecting grooves 1241 are provided, three mounting convex columns 111 are also correspondingly provided.

In an embodiment, the lower cover structure 200 includes a lower cover, and a needle hole is formed in the lower cover; when the lower cover is at the first position, the needle assembly 300 is capable of being hidden in the needle hole, and when the lower cover is located at the second position, the needle assembly 300 extends out from the needle hole.

In a specific embodiment, referring to FIG. 2 and FIG. 7, the lower cover is the first lower cover 210, the needle hole formed by the first lower cover 210 is the first needle hole 211, and the needle assembly 300 can be hidden into the first needle hole 211 or extend out from the first needle hole 211.

In the process of placing the coffee maker cover 20 over the coffee capsule machine, the coffee capsule 30 acts on the first lower cover 210, causing the first lower cover 210 to move away from the coffee capsule 30, that is, the first lower cover 210 is switched from the first position to the second position; at the same time, the needle assembly 300 is switched from a position at which the needle assembly 300 is hidden in the first needle hole 211 to a position at which the needle assembly 300 extends out from the first needle hole 211.

In an embodiment, the lower cover structure 200 further includes a sealing member, the sealing member is nested in a periphery of the needle hole, a plurality of sealing rings are convexly formed at the bottom of the sealing member, the plurality of sealing rings are spaced from the inside to the outside, the sealing member is provided with a through hole for the needle to pass through, and a diameter of the through hole is smaller than an outer diameter of the needle.

In a specific embodiment, referring to FIG. 2 and FIG. 7, the sealing member is a first sealing member 220, the first sealing member 220 is nested in a periphery of the first needle hole 211, a plurality of sealing rings 221 are convexly formed at the bottom of the first sealing member 220, the plurality of sealing rings 221 are spaced from the inside to the outside, the first sealing member 220 is provided with a first through hole 222 for the needle assembly 300 to pass through, and a diameter of the first through hole 222 is smaller than an outer diameter of the needle assembly 300.

The sealing rings 221 located at the bottom of the first sealing member 220 can form a tight fit with a surface layer of the coffee capsule 30. In addition, the diameter of first through hole 222 is designed to be smaller than the outer diameter of the needle assembly 300, so that two sealing structures are formed between the coffee capsule 30 and the first lower cover 210, and therefore the water in the coffee capsule 30 does not pass through the first lower cover 210 or enter the coffee maker cover 20.

Specifically, the first sealing structure is formed by causing the sealing rings 221 to abut against the surface layer of the coffee capsule 30, and the second sealing structure is formed by causing an outer wall of the needle assembly 300 to abut against a wall of the first through hole 222. The two sealing structures block all paths through which water can flow back.

In a specific embodiment, referring to FIG. 2 and FIG. 7, the coffee maker cover 20 further includes a first elastic telescopic structure 400 arranged between the first upper cover 110 and the first lower cover 210, so that the first lower cover 210 is capable of being switched between the first position and the second position relative to the first upper cover 110.

Herein, the elastic reset performance of the first elastic telescopic structure 400 is used to enable the first lower cover 210 to be spontaneously reset from the second position to the first position. That is, when the coffee maker cover 20 is removed, because the force of the coffee capsule 30 on the first lower cover 210 disappears, the first lower cover 210 can be reset under the action of the first elastic telescopic structure 400.

Certainly, in some embodiments, the first lower cover 210 may be switched back and forth between the first position and the second position only by relying on an external force without the arrangement of the first elastic telescopic structure 400.

In a more specific embodiment, referring to FIG. 2 and FIG. 7, the first elastic telescopic structure 400 includes a first elastic member 410 arranged between the first upper cover 110 and the first lower cover 210.

An elastic spring, silicone rubber, rubber or other components with elastic reset performance may be used as the first elastic member 410.

Further, in some embodiments, referring to FIG. 2 and FIG. 7, the first elastic telescopic structure 400 further includes a first guide post 420 arranged between the first upper cover 110 and the first lower cover 210, the first guide post 420 is capable of extending out of the first upper cover 110 or the first lower cover 210, and the first elastic member 410 sleeves the first guide post 420.

The first guide post 420 may be used as a part of the first upper cover 110 or the first lower cover 210. The first guide post 420 as a part of the first upper cover 110 is used as an example. In this case, the first guide post 420 extends out from the first lower cover 210, so that the first lower cover 210 can move along the first guide post 420, and the first guide post 420 guides the first lower cover 210.

The first guide post 420 may alternatively act as a separate part, and is connected to the first upper cover 110 or the first lower cover 210 by using a subsequent connection process.

In some other embodiments (reference may be made to a third elastic telescopic structure 600 below for relevant accompanying drawings herein), the first elastic telescopic structure 400 may further include a first guide seat arranged on the first upper cover 110 and a first guide protrusion arranged on the first lower cover 210. The first guide protrusion can be accommodated in the first guide seat, and a gap capable of accommodating the first elastic member 410 needs to be reserved between the two.

When the first lower cover 210 is switched from the first position to the second position, the first guide protrusion is inserted into the first guide seat, and the first elastic member 410 is gradually retracted into the gap between the first guide protrusion and the first guide seat. In this embodiment, the first guide protrusion and the first guide seat function the same as the first guide post 420 in the foregoing embodiment to guide the first lower cover 210, but differ from the foregoing embodiment in that, the first guide protrusion and the first guide seat are both located between the first upper cover 110 and the first lower cover 210, and do not need to extend out from the first upper cover 110 or the first lower cover 210.

It needs to be understood that the positions of the first guide protrusion and the first guide seat are interchangeable, that is, the first guide protrusion may be arranged on the first upper cover 110, and the first guide seat may be arranged on the first lower cover 210 at the same time.

To implement functions of the first upper cover 110, the first lower cover 210, the needle assembly 300, and the first elastic telescopic structure 400 described above, and to complete the assembly between the components, the first upper cover 110 and the first lower cover 210 may be implemented by using one of the following example structures, but it may be understood that the first upper cover 110 and the first lower cover 210 are not limited to the following example structures.

As a first example, referring to FIG. 2 and FIG. 7, the first upper cover 110 includes a cover portion 112 and an extension portion 113, the cover portion 112 has a side cover surface 1121 extending toward one side at which the lower cover structure 200 is located, the extension portion 113 extends from an edge of the side cover surface 1121 from the outside to the inside to form a support portion 1131 opposite to the cover portion 112, the support portion 1131 encloses and forms an opening 1131a, the first guide post 420 is arranged between the cover portion 112 and the extension portion 113, the first lower cover 210 includes a force-bearing portion 212 and a flange 213 located at an edge of the force-bearing portion 212, the flange 213 is provided with a through hole for the first guide post 420 to pass through, the flange 213 is provided corresponding to the support portion 1131, and the force-bearing portion 212 is provided corresponding to the opening 1131a.

It should be understood herein that when the first lower cover 210 is at the first position, the force-bearing portion 212 protrudes from the opening 1131a, so that the force-bearing portion 212 can be switched from the first position to the second position by the force of the coffee capsule 30.

In this example, the cover portion 112 and the extension portion 113 may have an integrated structure or a separate structure. In this example, when the first lower cover 210 is at the first position, the flange 213 can be supported on the support portion 1131, and the first elastic member 410 can keep the first lower cover 210 at the first position. In addition, in this example, the first guide post 420 is located between the cover portion 112 and the support portion 1131, and the first guide post 420 can implement a guiding function without extending out of the first upper cover 110 or the support portion 1131. In addition, the first guide post 420 formed on the first upper cover 110 is used as an example. In this case, the first upper cover 110 may be more compact in structure by causing a screw to penetrate through the support portion 1131 and be locked on the first guide post 420. When the force-bearing portion 212 bears force, the flange 213 drives the first elastic member 410 to compress, and the flange 213 together with the first elastic member 410 moves upward away from the support portion 1131 relative to the first guide post 420.

As another example (reference may be made to a second upper cover 130 and a second lower cover 230 below for relevant accompanying drawings herein), one of the first upper cover 110 and the first lower cover 210 may have a flat plate structure, and the other may have a structure with a concave cross section.

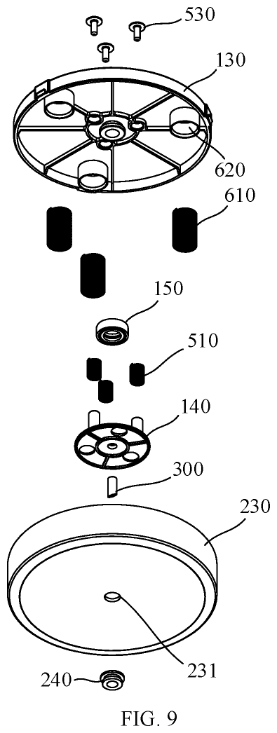

In a second type of embodiments, referring to FIG. 9 to FIG. 12, the needle assembly 300 is movably installed on the upper cover structure 100, and the lower cover structure 200 moves from the first position to the second position, the lower cover structure 200 is capable of acting on the upper cover structure 100 to move the needle assembly 300 to a position at which the water outlet channel of the needle assembly 300 is in hermetic communication with the water inlet channel 101.

In this embodiment, when the lower cover structure 200 is switched between the first position and the second position, the needle assembly 300 also moves for a certain stroke, thereby increasing the overall stroke of the needle assembly 300 and making the needle assembly 300 easier to hide.

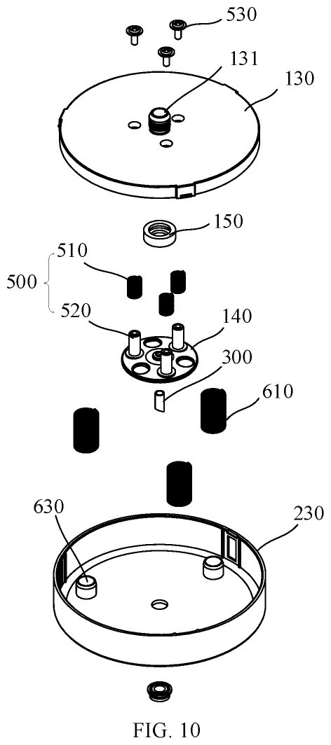

In a specific embodiment, referring to FIG. 9 and FIG. 10, the upper cover structure 100 includes a second upper cover 130 and a needle base 140, the needle base 140 is movably installed on the second upper cover 130, and the needle assembly 300 is installed on the needle base 140.

Herein, to implement the movable assembly between the needle base 140 and the second upper cover 130, a second elastic telescopic structure 500 may be arranged between the second upper cover 130 and the needle base 140.

Specifically, the needle base 140 is provided with a plurality of second guide posts 520 in a circumferential direction thereof, the plurality of second guide posts 520 are capable of penetrating through the second upper cover 130, the second guide posts 520 are each sleeved with a second elastic member 510, and the second elastic member 510 and the second guide post 520 form a second elastic telescopic structure 500.

When the lower cover structure 200 acts on the needle base 140, the lower cover structure 200 can drive the needle base 140 to move closer to the second upper cover 130, while the second guide post 520 penetrates through the second upper cover 130.

Further, a limiting member 530 such as a truss head screw may be assembled at an end of the second guide post 520 that can penetrate through the second upper cover 130, so that when under no action of the lower cover structure 200, the needle base 140 is pulled by the limiting member 530 such as the truss head screw to be kept at the current position.

Certainly, the second guide post 520 may alternatively be formed on the second upper cover 130, and in this case, the second guide post 520 extends out from the needle base 140. In this situation, a limiting member 530 such as a truss head screw may also be assembled on the second guide post 520 to support the needle base 140, so that the needle base 140 is kept at the current position.

Referring to FIG. 10 and FIG. 11, a second water inlet portion 131 is formed on one side of the second upper cover 130 facing the lower cover structure 200, the water inlet channel 101 is formed in the second water inlet portion 131, and a periphery of the second water inlet portion 131 is sleeved with a second sealing member 150.

For the specific forming manner, structure form and the like of the second upper cover 130 and the second water inlet portion 131, reference may be made to the foregoing description of the first upper cover 110, and details are not described herein. In addition, the second upper cover 130 may alternatively be designed to include a water inlet head 120 in a structural form.

The second sealing member 150 may form hermetic assembly between the needle base 140 and the water inlet channel 101, so that when the lower cover structure 200 moves to the second position, the needle assembly 300 installed on the needle base 140 may be in hermetic communication with the water inlet channel 101.

In an embodiment, the lower cover structure 200 includes a lower cover, and a needle hole is formed in the lower cover; when the lower cover is at the first position, the needle assembly 300 is capable of being hidden in the needle hole, and when the lower cover is located at the second position, the needle assembly 300 extends out from the needle hole.

In a specific embodiment, referring to FIG. 9 and FIG. 10, a lower cover included in the lower cover structure 200 is the second lower cover 230, a needle hole formed by the second lower cover 230 is a second needle hole 231, the needle assembly 300 can be hidden into the second needle hole 231 or extend out from the second needle hole 231, and a periphery of the second needle hole 231 is sleeved with a third sealing member 240.

The third sealing member 240 may be designed with reference to the foregoing first sealing member 220. For example, the third sealing member 240 has a second through hole 241 (as shown in FIG. 11) for the needle assembly 300 to pass through, and the like, and details are no longer described.

In the second type of embodiments, referring to FIG. 9 to FIG. 12, the coffee maker cover 20 further includes a third elastic telescopic structure 600 arranged between the second upper cover 130 and the second lower cover 230, so that the second lower cover 230 is capable of being switched between the first position and the second position relative to the second upper cover 130.

The third elastic telescopic structure 600 may be designed based on the first elastic telescopic structure 400 and the second elastic telescopic structure 500 described above, and details are no longer described herein.

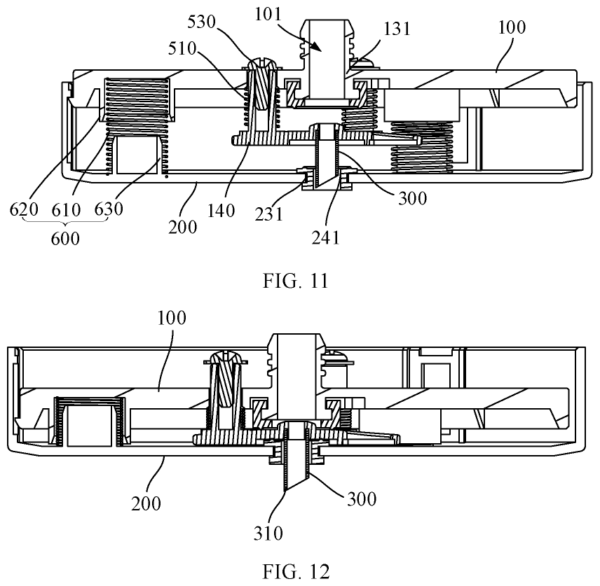

In addition, as a preferred solution, referring to FIG. 11 and FIG. 12, the third elastic telescopic structure 600 may include a second guide seat 620 arranged on the second upper cover 130 and a second guide protrusion 630 arranged on the second lower cover 230. The second guide protrusion 630 can be accommodated in the second guide seat 620, and a gap capable of accommodating the third elastic member 610 needs to be reserved between the two.

When the second lower cover 230 is switched from the first position to the second position, the second guide protrusion 630 is inserted into the second guide seat 620, and the third elastic member 610 is gradually retracted into the gap between the second guide protrusion 630 and the second guide seat 620. In this solution, the second guide protrusion 630 and the second guide seat 620 function the same as the first guide post 420 and the second guide post 520 in the foregoing embodiment to guide the second lower cover 230.

In addition to the above, embodiments of the application further provide two types of optional needle assemblies 300:

The first type of needle assembly 300 is as follows: referring to FIG. 11 and FIG. 12, the needle assembly 300 is a hollow tube penetrating in an axial direction, and a first tip 310 is formed at one end of the hollow tube.

The second type of needle assembly 300 is as follows: referring to FIG. 4 and FIG. 6, the needle assembly 300 includes a needle tube 320 and a second tip 330 connected to the needle tube 320. The needle tube 320 penetrates along an axial direction thereof and forms a needle tube flow channel 321 (that is, a water outlet channel). A needle outlet 322 communicated with the needle tube flow channel 321 is formed at one end of the needle tube 320 close to the second tip 330.

Referring to FIG. 11 or FIG. 12, the first tip 310 of the foregoing first type of needle assembly 300 is configured to pierce the capsule coffee 30, the inside of the needle assembly 300 is in hermetic communication with the water inlet channel 101, and water may flow out from the first tip 310.

The second tip 330 of the foregoing second type of needle assembly 300 is configured to pierce the capsule coffee 30, the needle tube flow channel 321 of the needle assembly 300 is in hermetic communication with the water inlet channel 101, and water may flow out from the needle outlet 322. In addition, a plurality of needle outlets 322 may be provided, and are uniformly spaced along the circumferential direction, so that the balance of water flowing out from the needle outlets 322 can be improved to improve brewing quality of the capsule coffee 30.

It should be noted that components that can achieve the same function in different embodiments listed herein may be applied to other embodiments, and feasible methods are not described in detail in each embodiment by using the accompanying drawings. In addition, it may be understood that on the basis of the embodiments listed herein, various structures may be further optimized and deformed, but these optimizations and deformations fall within the protection scope of the application without departing from the inventive concept of the application.

For example, when the first elastic telescopic structure 400 is described above, the feasible third elastic telescopic structure 600 is also described. For another example, when the first water inlet portion is described above, the second water inlet portion 131 is also described. In addition, the first upper cover 110 and the second upper cover 130 in the above-listed embodiments are interchangeable, the first lower cover 210 and the second lower cover 230 are interchangeable, the first sealing member 220 and the third sealing member 240 are interchangeable, and the two types of needle assemblies 300 listed are interchangeable. More interchange methods are no longer described in detail, and an interchange method that does not hinder the implementation of the technical solution may be adopted on the basis of the disclosure herein.

It should be noted that in the relevant embodiments listed herein, the number of some structural features and the number of parts and components used are not limited, and the specific number of these structural features and the specific number of the parts and components may be set as required. These structural features include the mounting convex column 111, the first guide post 420, the second guide post 520, the second guide seat 620, the second guide protrusion 630, and the like described above. These parts and components mainly include the first elastic member 410, the second elastic member 510, the third elastic member 610, and the like.

On the other hand, in the coffee maker cover 20 according to the embodiment of the application, the lower cover structure 200 is designed, for example, the foregoing first lower cover 210 and second lower cover 230 each have a sprinkling hole. In this case, when the lower cover structure 200 is at the first position, because the needle assembly 300 is in a hidden state, the water in the water inlet channel 101 may be sprinkled by using the sprinkling holes, so that the coffee maker cover 20 is not only suitable for brewing capsule coffee, but also can form a larger sprinkling area to brew coffee powder when the lower cover structure is at the first position.

Specifically, referring to the foregoing first type of embodiment, because the needle assembly 300 and the water inlet channel are always in hermetic communication, when the lower cover structure 200 is at the first position, the water in the water inlet channel 101 can be sprinkled to the first lower cover 210 through the needle assembly 300, and then the water is sprinkled through the sprinkling holes of the first lower cover 210.

With reference to the foregoing second type of embodiments, when the lower cover structure 200 is at the first position, the needle base 140 is separated from the upper cover structure 100. In this case, the water in the water inlet channel 101 can be sprinkled to the needle base 140 first, then sprinkled to the second lower cover 230, and finally sprinkled by using the sprinkling holes of the second lower cover 230.

More specifically, a cavity (referring to a symbol C in FIG. 7) communicated with the sprinkling hole is formed between the upper cover structure 100 and the lower cover structure 200, a first end of the needle assembly 300 is fixedly installed on one side of the upper cover structure 100 facing the cavity, a second end of the needle assembly 300 extends toward one side where the lower cover structure 200 is located, and the water outlet channel is communicated with the water inlet channel 101. When the lower cover structure 200 is at the first position, the needle outlet 322 is located inside the cavity, and the cavity is communicated with the water inlet channel 101 through the water outlet channel and the needle outlet 322, so that the sprinkling hole is communicated with the water inlet channel 101. In this case, the water sequentially passes through the water inlet channel 101, the water outlet channel, the needle outlet 322, the cavity, and the sprinkling hole. When the lower cover structure is at the second position, the needle outlet 322 extends to the outside of the lower cover structure 200, and disables communication between the water outlet channel and the cavity, thereby disabling communication between the sprinkling hole and the water inlet channel. In this case, the water passes through the water inlet channel 101, the water outlet channel, and the needle outlet 322 in sequence.

The technical features of the foregoing embodiments may be combined arbitrarily. To make the description concise, not all possible combinations of the various technical features in the foregoing embodiments are described. However, provided that no contradiction occurs to the combinations of these technical features, all the combinations should be considered as falling within the scope of the specification.

The foregoing embodiments only express several implementations of the application, and the description thereof is relatively specific and detailed, but it should not be understood as a limitation to the patent scope of the application. It should be noted that a person of ordinary skill in the art may further make several modifications and improvements without departing from the conception of the application. These modifications and improvements shall fall within the protection scope of the application. Therefore, the patent protection scope of the application should be subject to the appended claims.

What is claimed is:

1. A coffee maker cover, comprising:
an upper cover structure formed with a water inlet channel;
a lower cover structure, wherein the lower cover structure is installed on the upper cover structure in a manner of being capable of moving relative to the upper cover structure, and the lower cover structure has at least a first position away from the upper cover structure and a second position close to the upper cover structure; and
a needle assembly, wherein the needle assembly is installed on the upper cover structure, a water outlet channel is provided in the needle assembly, and the needle assembly has a needle outlet communicated with the water outlet channel, wherein
when the lower cover structure is at the first position, the needle assembly is hidden in the lower cover structure; and when the lower cover structure is at the second position, the needle assembly extends from the lower cover structure to expose the needle outlet and the water outlet channel of the needle assembly is in hermetic communication with the water inlet channel.

2. The coffee maker cover according to claim 1, wherein the needle assembly is fixedly installed on the upper cover structure, and the needle assembly is always in hermetic communication with the water inlet channel.

3. The coffee maker cover according to claim 2, wherein the upper cover structure comprises a first upper cover, a first water inlet portion is formed on one side of the first upper cover facing the lower cover structure, the first water inlet portion forms the water inlet channel, and the needle assembly is connected to the first water inlet portion.

4. The coffee maker cover according to claim 2, wherein the upper cover structure comprises a first upper cover and a water inlet head, the water inlet head is installed on one side of the first upper cover facing the lower cover structure, the water inlet head is formed with the water inlet channel, and the needle is connected to the water inlet head.

5. The coffee maker cover according to claim 2, wherein the coffee maker cover further comprises a first elastic telescopic structure arranged between the first upper cover and the lower cover structure, so that the lower cover structure is capable of being switched between the first position and the second position relative to the first upper cover.

6. The coffee maker cover according to claim 5, wherein the first elastic telescopic structure comprises a first elastic member arranged between the first upper cover and the lower cover structure; and
the first elastic telescopic structure further comprises a first guide post arranged between the first upper cover and the lower cover structure, and the first guide post is capable of extending out of the first upper cover or the lower cover structure, and the first elastic member sleeves the first guide post.

7. The coffee maker cover according to claim 6, wherein the first upper cover comprises a cover portion and an extension portion, the cover portion has a side cover surface extending toward one side at which the lower cover structure is located, the extension portion extends from an edge of the side cover surface from the outside to the inside to form a support portion opposite to the cover portion, the support portion encloses and forms an opening, the first guide post is arranged between the cover portion and the extension portion, the lower cover structure comprises a force-bearing portion and a flange located at an edge of the force-bearing portion, the flange is provided corresponding to the support portion, and the force-bearing portion is provided corresponding to the opening.

8. The coffee maker cover according to claim 1, wherein the needle assembly is movably installed on the upper cover structure, and the lower cover structure moves from the first position to the second position, the lower cover structure is capable of acting on the upper cover structure to move the needle assembly to a position at which the water outlet channel of the needle assembly is in hermetic communication with the water inlet channel.

9. The coffee maker cover according to claim 8, wherein the upper cover structure comprises a second upper cover and a needle base, the needle base is movably installed on the second upper cover, and the needle assembly is installed on the needle base.

10. The coffee maker cover according to claim 9, wherein a second water inlet portion is formed on one side of the second upper cover facing the lower cover structure, the water inlet channel is formed in the second water inlet portion, and a periphery of the second water inlet portion is sleeved with a second sealing member.

11. The coffee maker cover according to claim 10, wherein the needle base is provided with a plurality of second guide posts in a circumferential direction thereof, the plurality of second guide posts are capable of penetrating through the second upper cover, the second guide posts are each sleeved with a second elastic member, and the second elastic member and the second guide post form a second elastic telescopic structure.

12. The coffee maker cover according to claim 11, wherein the coffee maker cover further comprises a third elastic telescopic structure arranged between the second upper cover and the lower cover structure, so that the lower cover structure is capable of being switched between the first position and the second position relative to the second upper cover.

13. The coffee maker cover according to claim 2, wherein the lower cover structure comprises a lower cover, and a needle hole is formed in the lower cover; when the lower cover is at the first position, the needle assembly is capable of being hidden in the needle hole, and when the lower cover is located at the second position, the needle outlet of the needle assembly extends out from the needle hole.

14. The coffee maker cover according to claim 13, wherein the lower cover structure further comprises a sealing member, the sealing member is nested in a periphery of the needle hole, a plurality of sealing rings are convexly formed at the bottom of the sealing member, the plurality of sealing rings are spaced with each other from the inside to the outside, the sealing member is provided with a through hole for the needle assembly to pass through, and a diameter of the through hole is smaller than an outer diameter of the needle assembly.

15. The coffee maker cover according to claim 2, wherein the lower cover structure has a sprinkling hole; when the lower cover structure is at the first position, a cavity communicated with the sprinkling hole is formed between the upper cover structure and the lower cover structure; a first end of the needle assembly is fixedly installed on a side of the upper cover structure facing the cavity, a second end of the needle assembly extends toward a side where the lower cover structure is located, and the water outlet channel is communicated with the water inlet channel;
when the lower cover structure is at the first position, the needle outlet is located inside the cavity, and the cavity is communicated with the water inlet channel through the water outlet channel and the needle outlet, so that the sprinkling hole is communicated with the water inlet channel; and
when the lower cover structure is at the second position, the needle outlet extends to the outside of the lower cover structure, and disables communication between the water outlet channel and the cavity, thereby disabling communication between the sprinkling hole and the water inlet channel.

16. A capsule coffee maker, comprising a machine base, wherein the capsule coffee maker further comprises the coffee maker cover as recited in claim 1, the coffee maker cover being rotatably installed on the machine base.
